(19) United States
(12) Patent Application Publication
(10) Pub. No.: US 2016/0052104 A1
(43) Pub. Date: Feb. 25, 2016

(54) POLISHING APPARATUS

(71) Applicant: EBARA CORPORATION, Tokyo (JP)

(72) Inventor: Tomoatsu ISHIBASHI, Tokyo (JP)

(21) Appl. No.: 14/828,158

(22) Filed: Aug. 17, 2015

(30) Foreign Application Priority Data
Aug. 21, 2014 (JP) 2014-168718

(51) Int. Cl. B24B 37/34; B08B 3/10; B24B 37/10

(52) U.S. Cl. CPC B24B 37/34; B24B 37/10; B08B 3/10

(57) ABSTRACT

A polishing apparatus in which a liquid containing a slurry hardly enters into a gap between a top ring body and a retainer ring during polishing, and the slurry can be discharged by cleaning even if the liquid containing the slurry enters into the gap, and slurry particles can be prevented from being attached to a surface of a substrate (wafer) when the substrate (wafer) is released is disclosed. The polishing apparatus includes a top ring having a top ring body and a retainer ring provided at an outer circumferential portion of the top ring body, and configured to hold a substrate to be polished and to press the substrate against the polishing surface, and a cleaning mechanism provided at a substrate transfer position for transferring the substrate to the top ring or receiving the substrate from the top ring, and having a cleaning nozzle configured to eject a cleaning liquid toward the top ring. The retainer ring has a recess formed over an entire circumference of an inner circumferential surface of the retainer ring. The cleaning nozzle is configured to eject the cleaning liquid toward the recess of the retainer ring.

### CROSS REFERENCE TO RELATED APPLICATION

This document claims priority to Japanese Patent Application Number 2014-168718 filed Aug. 21, 2014, the entire contents of which are hereby incorporated by reference.

### BACKGROUND

In recent years, high integration and high density in semiconductor device demands smaller and smaller wiring patterns or interconnections and also more and more interconnection layers. Multilayer interconnections in smaller circuits result in greater steps which reflect surface irregularities on lower interconnection layers. An increase in the number of interconnection layers makes film coating performance (step coverage) poor over stepped configurations of thin films. Therefore, better multilayer interconnections need to have the improved step coverage and proper surface planarization. Further, since the depth of focus of a photolithographic optical system is smaller with miniaturization of a photolithographic process, a surface of the semiconductor device needs to be planarized such that irregular steps on the surface of the semiconductor device will fall within the depth of focus.

Thus, in a manufacturing process of a semiconductor device, it increasingly becomes important to planarize a surface of the semiconductor device. One of the most important planarizing technologies is chemical mechanical polishing (CMP). In the chemical mechanical polishing, while a polishing liquid (slurry) containing abrasive particles such as silica (SiO2) therein is supplied onto a polishing surface of a polishing pad, a wafer is brought into sliding contact with the polishing surface and polished by using a polishing apparatus.

The polishing apparatus of this kind includes a polishing table supporting a polishing pad, and a top ring (polishing head) for holding a wafer. When the wafer is polished with such a polishing apparatus, the wafer is held and pressed against the polishing surface of the polishing pad under a predetermined pressure by the top ring. At this time, the polishing table and the top ring are moved relative to each other to bring the wafer into sliding contact with the polishing surface, so that the surface of the wafer is polished to a flat mirror finish.

If a relative pressing force applied between the wafer and the polishing surface of the polishing pad during polishing is not uniform over the entire surface of the wafer, insufficient polishing or excessive polishing would occur depending on the pressing forces applied to respective portions of the wafer. Thus, in order to uniformize the pressing force applied to the wafer, the top ring has a pressure chamber formed by a membrane (elastic membrane) at a lower part thereof. This pressure chamber is supplied with a fluid, such as air, to press the wafer through the membrane under a fluid pressure.

In this case, generally, the polishing pad is so elastic that pressing forces applied to a peripheral portion of the wafer, being polished, become non-uniform, and hence only the peripheral portion of the semiconductor wafer may excessively be polished, which is referred to as “edge rounding”. In order to prevent such edge rounding from occurring and prevent the wafer from slipping out of the top ring, a retainer ring for holding the peripheral edge of the wafer is provided so as to be vertically movable with respect to the top ring body, thereby pressing an annular portion of the polishing surface of the polishing pad that corresponds to the peripheral portion of the wafer.

In this manner, when the retainer ring for holding the peripheral edge of the wafer is provided so as to be vertically movable with respect to the top ring body, a gap is formed between the membrane fixed to the top ring body and the retainer ring. Thus, during polishing, this gap allows a slurry (polishing liquid) supplied onto the polishing surface to enter therethrough into an interior of the top ring.

The inventors of the present application have intensively studied the phenomenon that the slurry (polishing liquid) enters into the gap between the membrane and the retainer ring in the conventional top ring, and the effect that the above phenomenon has on the subsequent processes. Consequently, the inventors of the present application have obtained the following knowledge:

FIGS. 14A, 14B and 14C are views showing the relationship between the membrane 101 and the retainer ring 102 in the conventional top ring 100. FIG. 14A shows the state during polishing of the wafer, FIG. 14B shows the state during transfer of the wafer, and FIG. 14C shows the state at the time of wafer release.

As shown in FIG. 14A, while the wafer W is pressed against the polishing pad 103 by the membrane 101 provided on the top ring body (wafer holding portion) and the retainer ring 102 is pressed against the polishing pad 103, the wafer W is polished. At this time, since a small gap (about 0.5 mm) is formed between the membrane 101 and the retainer ring 102, the slurry (polishing liquid) supplied onto the polishing pad 103 rises in the narrow gap by capillary action, and thus the slurry enters into an interior of the top ring.

As shown in FIG. 14B, while the wafer W is held by the membrane 101, the wafer W is transported. At this time, the retainer ring 102 is lowered downwardly. Although a cleaning liquid is ejected from a nozzle 104 toward the gap between the membrane 101 and the retainer ring 102, a majority of the cleaning liquid bounces off and does not enter into the gap because the gap is filled with the liquid containing the slurry.

As shown in FIG. 14C, at the time of wafer release, a mixed fluid of a liquid and a gas is ejected from a wafer release nozzle toward an interface between the wafer W and the membrane 101 in a state in which the retainer ring 102 is pushed up by a push-up mechanism 105 (shown by dotted lines). At this time, the spray of the fluid for release goes around to cause slurry particles, with which the gap between the membrane 101 and the retainer ring 102 is filled, to be attached to the surface of the wafer.

As can be seen from FIGS. 14A, 14B and 14C, the inventors of the present application have obtained the following knowledge:

In the conventional top ring, the slurry is liable to enter into the gap between the membrane and the retainer ring by the capillary action during polishing, and cleaning of the gap cannot be sufficiently performed. Therefore, when the wafer (substrate) is released from the top ring, the slurry particles with which the gap is filled are sprayed on the wafer (substrate) and are attached to the surface of the wafer, thus increasing the load at the cleaning side.

### SUMMARY OF THE INVENTION

According to an embodiment, there is provided a polishing apparatus in which a liquid containing a slurry hardly enters into a gap between a top ring body and a retainer ring during polishing, and the slurry can be discharged by cleaning even if the liquid containing the slurry enters into the gap, and slurry particles can be prevented from being attached to a surface of a substrate (wafer) when the substrate (wafer) is released.

Embodiments, which will be described below, relate to a polishing apparatus, and more particularly to a polishing apparatus for polishing and planarizing a surface of an object to be polished (substrate) such as a semiconductor wafer.

In an embodiment, there is provided a polishing apparatus comprising: a polishing table having a polishing surface; a top ring having a top ring body and a retainer ring provided at an outer circumferential portion of the top ring body, and configured to hold a substrate to be polished and to press the substrate against the polishing surface; a cleaning mechanism provided at a substrate transfer position for transferring the substrate to the top ring or receiving the substrate from the top ring, and having a cleaning nozzle configured to eject a cleaning liquid toward the top ring; wherein the retainer ring has a recess formed over an entire circumference of an inner circumferential surface of the retainer ring at a position above the lower surface of the retainer ring; and wherein the cleaning nozzle is configured to eject the cleaning liquid toward the recess of the retainer ring.

According to the embodiment, because the retainer ring has a recess formed over an entire circumference of an inner circumferential surface of the retainer ring at a position above the lower surface of the retainer ring, the gap between the outer circumferential surface of the top ring body and the inner circumferential surface of the retainer ring spreads inwardly. Therefore, when the substrate is polished, a liquid containing a slurry hardly enters the gap due to the capillary action. Further, because cleaning the cleaning nozzle ejects the cleaning liquid toward the recess of the retainer ring, the slurry which has entered the gap in small amount can be washed away.

In an embodiment, the cleaning mechanism further comprises a substrate release nozzle configured to eject a fluid when the substrate is released from the top ring body.

According to the embodiment, the fluid is ejected from the substrate release nozzle provided in the cleaning mechanism to assist the release (removal) of the substrate from the top ring body.

In an embodiment, the cleaning mechanism comprises a plurality of cleaning units provided at intervals in a circumferential direction so as to surround the top ring, and each cleaning unit has the cleaning nozzle; and wherein the cleaning nozzle is configured to eject the cleaning liquid toward the recess of the retainer ring to clean the recess of the retainer ring while the top ring is rotated.

According to the embodiment, the cleaning mechanism has a plurality of cleaning units provided at intervals in a circumferential direction so as to enclose the top ring, and the cleaning liquid is ejected toward the recess of the retainer ring from the cleaning nozzle provided in each cleaning unit while the top ring is rotated. Therefore, the entire circumference of the gap between the top ring body and the retainer ring can be cleaned everywhere.

In an embodiment, the cleaning mechanism doubles as a support member configured to receive the substrate from the top ring.

In an embodiment, the retainer ring has a hydrophobic surface on an inner circumferential surface below the recess.

According to the embodiment, because the retainer ring has a hydrophobic surface on an inner circumferential surface below the retainer ring recess, the liquid containing the slurry hardly enters the gap due to the capillary action when the substrate is polished.

In an embodiment, the top ring body has a hydrophobic surface at least below the surface facing the recess.

According to the embodiment, because the top ring body has a hydrophobic surface formed at a position lower than a surface facing the recess of the retainer ring, the liquid containing the slurry hardly enters the gap due to the capillary action.

In an embodiment, when the top ring is located at the substrate transfer position, the lower end of the recess of the retainer ring is located at a position below the lower surface of the substrate held by the top ring.

According to the embodiment, when the top ring is located at the substrate transfer position, the lower end of the recess of the retainer ring is located at a position lower than the lower surface of the substrate held by the top ring. Therefore, the slurry which has partly entered the gap is exposed outwardly, and thus can be easily cleaned. The cleaning liquid is ejected toward the inner wall of the recess of the retainer ring from the cleaning nozzle to remove a small amount of slurry which has entered the gap, thus achieving a high cleaning performance.

In an embodiment, the recess of the retainer ring has a cross-sectional shape which is curved in a substantially arcuate shape whose curvature in a lower part or a central part is larger than that in an upper part.

In an embodiment, the recess of the retainer ring has a cross-sectional shape formed by a straight line extending obliquely upward from a lower part of the inner circumferential surface of the retainer ring and a straight line extending obliquely downward from an upper part of the inner circumferential surface of the retainer ring, the two straight lines intersecting at an obtuse angle.

In an embodiment, the cleaning nozzle is set such that an inclined angle with respect to a horizontal plane is in the range of 20° to 80°.

In an embodiment, the cleaning nozzle is provided to be inclined at a predetermined angle toward an upstream side of rotation direction of the retainer ring with respect to a vertical plane.

According to the embodiment, the cleaning liquid ejected from the cleaning nozzle is set so as to hit the wall surface of the retainer ring in a reverse direction toward the upstream side of rotation direction of the retainer ring with respect to the moving direction of the retainer ring wall surface. Therefore, an impact when the cleaning liquid hits the surface to be cleaned can be increased to achieve a high cleaning performance.

In an embodiment, the cleaning mechanism has a push-up mechanism configured to push up the retainer ring when the substrate is released from the top ring body.

In an embodiment, the cleaning nozzle is capable of ejecting a gas.

In an embodiment, the cleaning mechanism has another cleaning nozzle configured to clean a lower surface and/or an outer circumferential surface of the retainer ring.

The above-described embodiments offer the following effects.

(1) The liquid containing the slurry hardly enters into the gap between the top ring body and the retainer ring during polishing, and the slurry can be discharged by cleaning even if the liquid containing the slurry enters into the gap. Therefore, slurry particles can be prevented from being attached to the surface of the substrate (wafer) when the substrate (wafer) is released.
(2) Because the slurry particles can be prevented from being attached to the surface of the substrate when the substrate is released, the load at the subsequent cleaning side can be reduced.
(3) Because the gap between the top ring body and the retainer ring is cleaned when the substrate is subjected to rinse treatment after polishing in the substrate transfer position, there is no fear of lowering the throughput (productivity) of the substrate.

### BRIEF DESCRIPTION OF THE DRAWINGS

FIG. 1 is a plan view showing an overall arrangement of a polishing apparatus according to an embodiment;

FIG. 2 is a schematic perspective view showing a first polishing unit;

FIG. 3 is a view showing the relationship between the first polishing unit and the second transfer position (wafer transfer position);

FIGS. 4A and 4B are views showing the relationship between a cleaning mechanism shown in FIG. 3, a pusher and a top ring, FIG. 4A is a schematic plan view and FIG. 4B is a schematic cross-sectional view which overlays a view as viewed from line A-A and a view as viewed from line B-B;

FIG. 5 is a schematic cross-sectional view showing the relationship between the top ring and each cleaning unit of the cleaning mechanism;

FIGS. 6A and 6B are perspective views showing the recess formed in the retainer ring, respectively;

FIGS. 7A and 7B are views showing the cleaning unit of the cleaning mechanism shown in FIG. 5, FIG. 7A is a plan view showing the cleaning unit, and FIG. 7B is a front view showing the cleaning unit;

FIGS. 8A and 8B are views showing another embodiment of the cleaning mechanism, FIG. 8A is a schematic partial cross-sectional view showing the state in which the wafer is rinsed, and FIG. 8B is a schematic cross-sectional view showing the state in which the wafer is released;

FIGS. 9A and 9B are views showing the details of the cleaning unit of the cleaning mechanism shown in FIG. 8, FIG. 9A is a plan view showing the cleaning mechanism, and FIG. 9B is a front view showing the cleaning unit.

FIGS. 10A, 10B and 10C are views showing the relationship between the membrane and the retainer ring in the top ring, FIG. 10A shows the state in which the wafer is being polished, FIG. 10B shows the state in which the wafer is transported, and FIG. 10C shows the state in which the wafer is released;

FIG. 11 is a flowchart showing an example of a wafer treatment process conducted by the polishing apparatus having the configuration shown in FIGS. 1 to 9;

FIG. 12 is a flowchart showing another example of the wafer treatment process conducted by the polishing apparatus having the configuration shown in FIGS. 1 to 9;

FIG. 13 is a flowchart showing still another example of the wafer treatment process conducted by the polishing apparatus having the configuration shown in FIGS. 1 to 9; and

FIGS. 14A, 14B and 14C are views showing the relationship between the membrane and the retainer ring in the conventional top ring, FIG. 14A shows the state during polishing of the wafer, FIG. 14B shows the state during transfer of the wafer, and FIG. 14C shows the state at the time of wafer release.

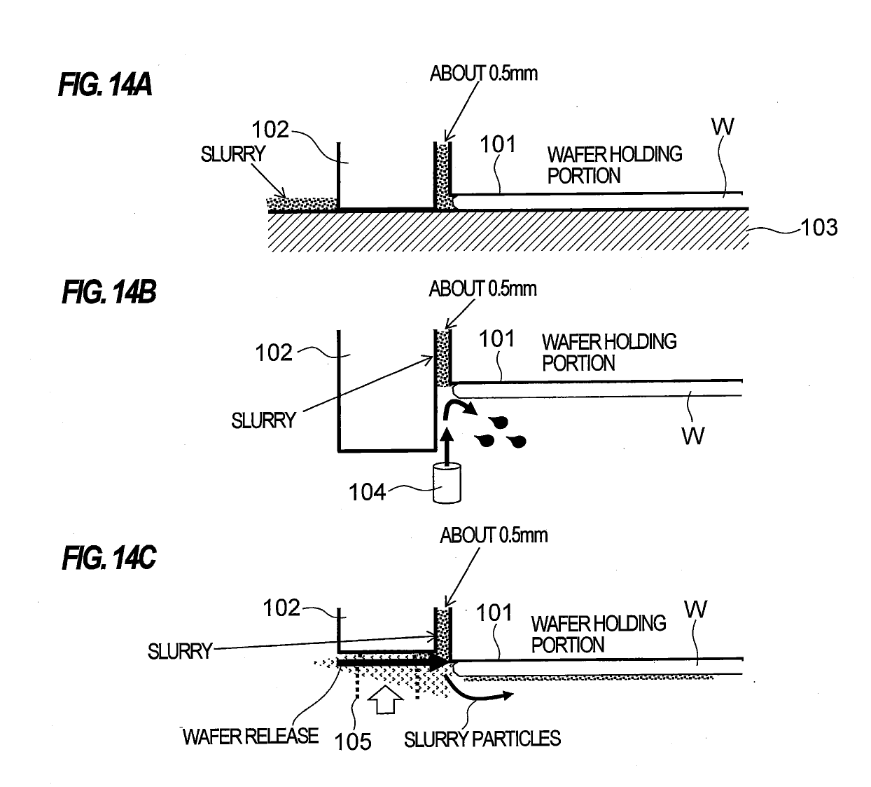

### DESCRIPTION OF EMBODIMENTS

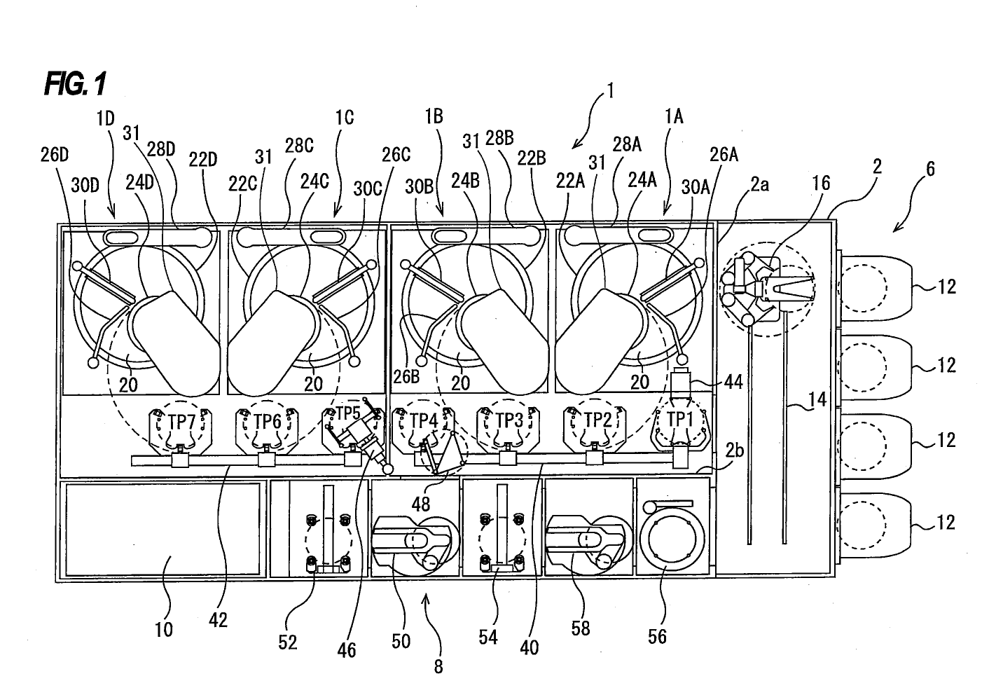

A polishing apparatus according to embodiments will be described in detail below with reference to FIGS. 1 to 13. In FIGS. 1 to 13, identical or corresponding parts are denoted by identical reference numerals throughout the views and their repetitive explanations will be omitted.

FIG. 1 is a plan view showing an overall arrangement of a polishing apparatus according to an embodiment. As shown in FIG. 1, the polishing apparatus 1 has a housing 2 in approximately a rectangular shape. An interior space of the housing 2 is divided by partitions 2a, 2b into a load-unload section 6, a polishing section 1, and a cleaning section 8. The polishing apparatus includes an operation controller 10 configured to control wafer processing operations.

The load-unload section 6 has load ports 12 on which wafer cassettes are placed, respectively. A plurality of wafers are stored in each wafer cassette. The load-unload section 6 has a moving mechanism 14 extending along an arrangement direction of the load ports 12. A transfer robot (loader) 16 is provided on the moving mechanism 14, so that the transfer robot 16 can move along the arrangement direction of the wafer cassettes. The transfer robot 16 moves on the moving mechanism 14 so as to access the wafer cassettes mounted to the load ports 12.

The polishing section 1 is an area where a wafer is polished. This polishing section 1 includes a first polishing unit 1A, a second polishing unit 1B, a third polishing unit 1C, and a fourth polishing unit 1D. The first polishing unit 1A includes a first polishing table 22A to which a polishing pad 20, having a polishing surface, is attached, a first top ring 24A for holding a wafer and pressing the wafer against the polishing pad 20 on the first polishing table 22A to polish the wafer, and a first polishing liquid supply nozzle 26A for supplying a polishing liquid (e.g., slurry) and a dressing liquid (e.g., pure water) onto the polishing pad 20. The first polishing unit 1A further includes a first dressing unit 28A for dressing the polishing surface of the polishing pad 20, and a first atomizer 30A for ejecting a mixture fluid of a liquid (e.g., pure water) and a gas (e.g., nitrogen gas) or a liquid (e.g., pure water), in an atomized state, onto the polishing surface of the polishing pad 20.

Similarly, the second polishing unit 1B includes a second polishing table 22B to which a polishing pad 20 is attached, a second top ring 24B, a second polishing liquid supply nozzle 26B, a second dressing unit 28B, and a second atomizer 30B. The third polishing unit 1C includes a third polishing table 22C to which a polishing pad 20 is attached, a third top ring 24C, a third polishing liquid supply nozzle 26C, a third dressing unit 28C, and a third atomizer 30C. The fourth polishing unit 1D includes a fourth polishing table 22D to which a polishing pad 20 is attached, a fourth top ring 24D, a fourth polishing liquid supply nozzle 26D, a fourth dressing unit 28D, and a fourth atomizer 30D.

A first linear transporter 40 is disposed adjacent to the first polishing unit 1A and the second polishing unit 1B. The first linear transporter 40 is a mechanism for transporting a wafer between four transfer positions (i.e., a first transfer position TP1, a second transfer position TP2, a third transfer position TP3 and a fourth transfer position TP4). A second linear transporter 42 is disposed adjacent to the third polishing unit 1C and the fourth polishing unit 1D. The second linear transporter 42 is a mechanism for transporting a wafer between three transfer positions (i.e., a fifth transfer position TP5, a sixth transfer position TP6, and a seventh transfer position TP7).

A lifter 44 for receiving the wafer from the transfer robot 16 is disposed adjacent to the first transfer position TP1. The wafer is transferred from the transfer robot 16 to the first linear transporter 40 via the lifter 44. A shutter (not shown) is provided on the partition 2a so as to be located between the lifter 44 and the transfer robot 16. When the wafer is to be transported, the shutter is opened to allow the transfer robot 16 to transfer the wafer to the lifter 44.

The wafer is transferred to the lifter 44 by the transfer robot 16, then transferred from the lifter 44 to the first linear transporter 40, and then transported to the polishing units 1A, 1B by the first linear transporter 40. The top ring 24A of the first polishing unit 1A is movable between a position above the first polishing table 22A and the second transfer position TP2 by a swing motion of the top ring head 31. Therefore, the wafer is transferred to and from the top ring 24A at the second transfer position TP2.

Similarly, the top ring 24B of the second polishing unit 1B is movable between a position above the polishing table 22B and the third transfer position TP3, and the wafer is transferred to and from the top ring 24B at the third transfer position TP3. The top ring 24C of the third polishing unit 1C is movable between a position above the polishing table 22C and the sixth transfer position TP6, and the wafer is transferred to and from the top ring 24C at the sixth transfer position TP6. The top ring 24D of the fourth polishing unit 1D is movable between a position above the polishing table 22D and the seventh transfer position TP7, and the wafer is transferred to and from the top ring 24D at the seventh transfer position TP7.

A swing transporter 46 is provided between the first linear transporter 40, the second linear transporter 42, and the cleaning section 8. The transfer of the wafer from the first linear transporter 40 to the second linear transporter 42 is performed by the swing transporter 46. The wafer is transported to the third polishing unit 1C and/or the fourth polishing unit 1D by the second linear transporter 42.

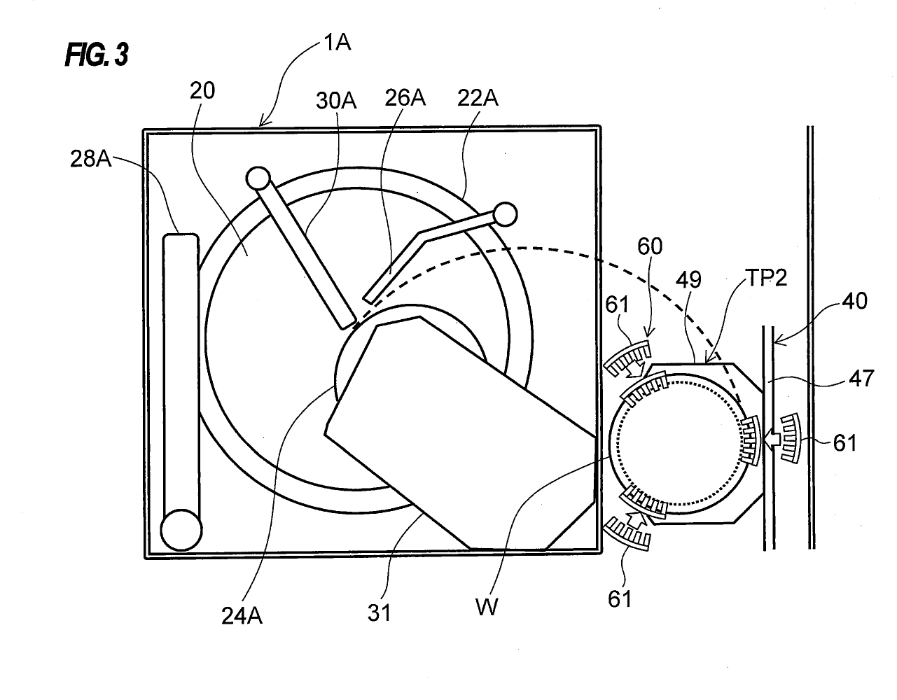

A temporary stage 48 for the wafer is disposed beside the swing transporter 46. This temporary stage 48 is mounted on a non-illustrated frame. As shown in FIG. 3, the temporary stage 48 is disposed adjacent to the first linear transporter 40 and located between the first linear transporter 40 and the cleaning section 8. The swing transporter 46 is configured to transport the wafer between the fourth transfer position TP4, the fifth transfer position TP5, and the temporary stage 48.

The wafer, once placed on the temporary stage 48, is transported to the cleaning section 8 by a first transfer robot 50 of the cleaning section 8. The cleaning section 8 includes a primary cleaning unit 52 and a secondary cleaning unit 54 each for cleaning the polished wafer with a cleaning liquid, and a drying unit 56 for drying the cleaned wafer. The first transfer robot 50 is operable to transport the wafer from the temporary stage 48 to the primary cleaning unit 52 and further transport the wafer from the primary cleaning unit 52 to the secondary cleaning unit 54. A second transfer robot 58 is disposed between the secondary cleaning unit 54 and the drying unit 56. This second transfer robot 58 is operable to transport the wafer from the secondary cleaning unit 54 to the drying unit 56.

The dried wafer is removed from the drying unit 56 and returned to the wafer cassette by the transfer robot 16. In this manner, a series of processes including polishing, cleaning, and drying of the wafer is performed.

The first polishing unit 1A, the second polishing unit 1B, the third polishing unit 1C, and the fourth polishing unit 1D have the same structure as each other. Therefore, the first polishing unit 1A will be described below.

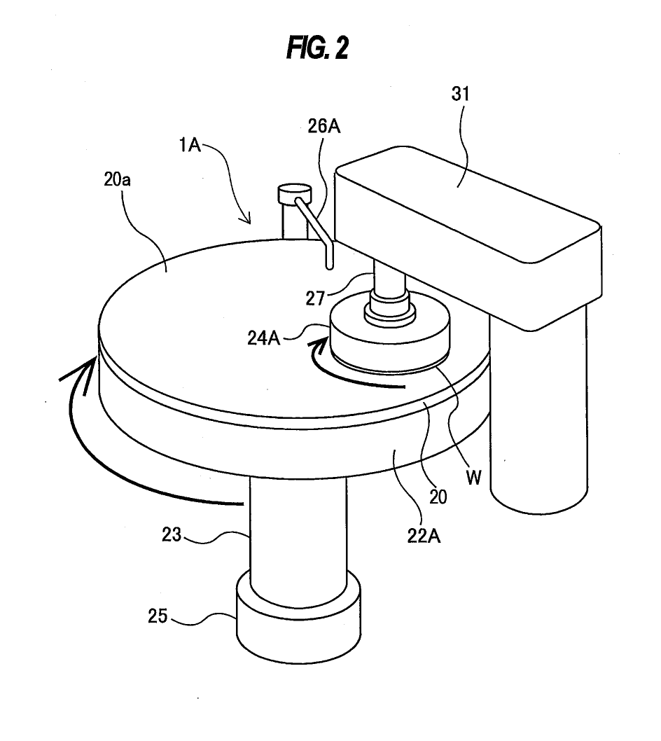

FIG. 2 is a schematic perspective view showing the first polishing unit 1A. As shown in FIG. 2, the first polishing unit 1A includes the polishing table 22A supporting the polishing pad 20, the top ring 24A for pressing the wafer W against the polishing pad 20, and the polishing liquid supply nozzle 26A for supplying the polishing liquid (e.g., slurry) onto the polishing pad 20. In FIG. 2, illustration of the first dressing unit 28A and the first atomizer 30A is omitted.

The polishing table 22A is coupled via a table shaft 23 to a table motor 25 disposed below the polishing table 22A, so that the polishing table 22A is rotated by the table motor 25 in a direction indicated by arrow. The polishing pad 20 is attached to an upper surface of the polishing table 22A. The polishing pad 20 has an upper surface, which provides a polishing surface 20a for polishing the wafer W. The top ring 24A is secured to a lower end of a top ring shaft 27. The top ring 24A is configured to be able to hold the wafer W on its lower surface by vacuum suction. The top ring shaft 27 is coupled to a rotating mechanism (not shown) disposed in a top ring head 31, so that the top ring 24A is rotated by the rotating mechanism through the top ring shaft 27.

A polishing process of the surface of the wafer W is performed as follows. The top ring 24A and the polishing table 22A are rotated in respective directions indicated by arrows, and the polishing liquid (the slurry) is supplied from the polishing liquid supply nozzle 26A onto the polishing pad 20. In this state, the wafer W is pressed against the polishing surface 20a of the polishing pad 20 by the top ring 24A. The surface of the wafer W is polished by a mechanical action of abrasive particles contained in the polishing liquid and a chemical action of a chemical component contained in the polishing liquid.

The wafer W which has been polished by the first polishing unit 1A shown in FIG. 2 is moved to the second transfer position TP2 (see FIG. 1) by the swing motion of the top ring head 31. The second transfer position TP2 functions as a wafer transfer position, and the wafer W is removed (released) in the second transfer position TP2. A pusher is provided in the second transfer position (wafer transfer position) TP2, so that the polished wafer W is transferred to a transfer stage of the first linear transporter 40 by the vertical motion of the pusher.

FIG. 3 is a view showing the relationship between the first polishing unit 1A and the second transfer position (wafer transfer position) TP2. The relationship between the second polishing unit 1B and the third transfer position TP3, the relationship between the third polishing unit 1C and the sixth transfer position TP6, and the relationship between the fourth polishing unit 1D and the seventh transfer position TP7 are the same as those in FIG. 3. As shown in FIG. 3, the top ring 24A is movable between a position above the first polishing table 22A and the second transfer position (wafer transfer position) TP2 by the swing motion of the top ring head 31. A pusher (described later) is disposed in the second transfer position (wafer transfer position) TP2. In FIG. 3, a travelling rail 47 of the first linear transporter 40 is illustrated. A transfer stage 49 is movable along the travelling rail 47. The state in which the wafer W is placed on the transfer stage 49 is shown in FIG. 3. Further, a cleaning mechanism 60 for cleaning the gap between the membrane and the retainer ring in the top ring 24A is disposed in the second transfer position (wafer transfer position) TP2. The cleaning mechanism 60 has a plurality of cleaning units 61 each having a comb teeth shape (comprising three cleaning units 61 in the illustrated example). Each of the cleaning units 61 is capable of reciprocating between a radially outward position and a radially inward position as shown by arrows.

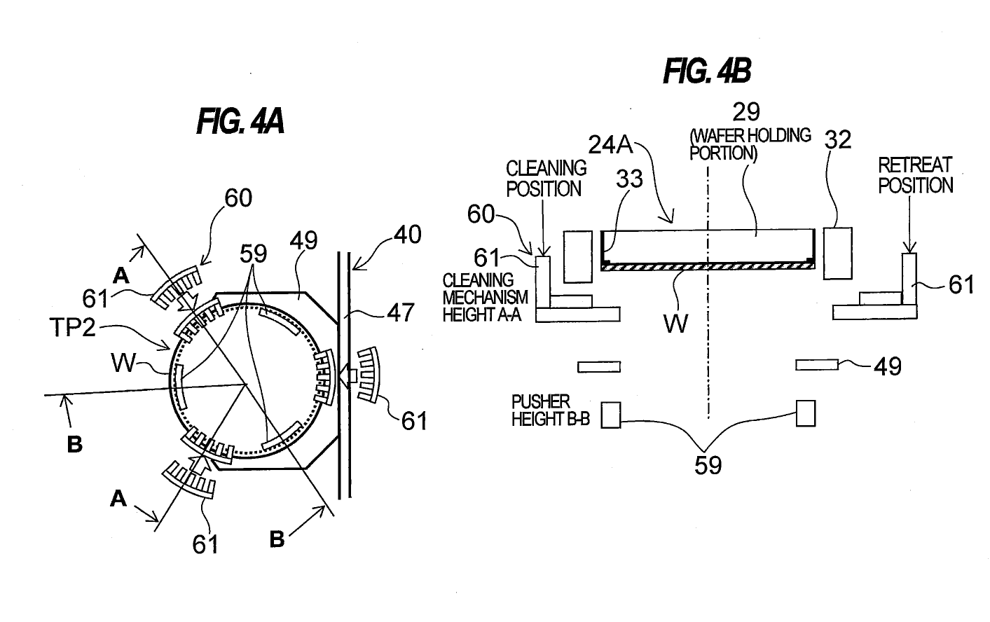

FIGS. 4A and 4B are views showing the relationship between the cleaning mechanism 60 shown in FIG. 3, the pusher 59 and the top ring 24A. FIG. 4A is a schematic plan view and FIG. 4B is a schematic cross-sectional view which overlays a view as viewed from line A-A and a view as viewed from line B-B.

As shown in FIGS. 4A and 4B, the transfer stage 49 of the first linear transporter 40 is positioned below the cleaning mechanism 60 comprising the plural cleaning units 61 each having a comb teeth shape, and the pusher 59 is positioned below the transfer stage 49. Each cleaning unit 61 of the cleaning mechanism 60 is capable of reciprocating between a radially outward position (retreat position) and a radially inward position (cleaning position). Each cleaning unit 61 of the cleaning mechanism 60 and the pusher 59 are disposed at different positions on the circumference of the wafer W as viewed from above, and thus each cleaning unit 61 and the pusher 59 are set so as not to interfere with each other.

FIG. 4B shows the state in which the top ring 24A holding the wafer W is positioned at the second transfer position (wafer transfer position) TP2, the top ring 24A being shown in such a way that only the top ring body (wafer holding portion) 29 having the membrane 33 and the lower part of the retainer ring 32 are shown. As shown in FIG. 4B, the cleaning unit 61 of the cleaning mechanism 60 is positioned below the top ring 24A, the transfer stage 49 is positioned below the cleaning unit 61, and the pusher 59 is positioned below the transfer stage 49. When the wafer W is transferred to the top ring 24A by the pusher 59, the cleaning mechanism 60 retreats to the retreat position. When the cleaning mechanism 60 cleans the gap between the top ring 24A and the retainer ring 32, the cleaning mechanism 60 moves forward to the cleaning position. In the cleaning position, while the top ring 24A is rotated, the cleaning mechanism 60 ejects the cleaning liquid toward the top ring 24A to clean the gap between the retainer ring 32 and the membrane 33. When the cleaning mechanism 60 cleans the gap between the retainer ring 32 and the membrane 33, the retainer ring 32 is in a lowered state, i.e., the lower surface of the retainer ring 32 is located at the position lower than the lower surface of the wafer W. Subsequently, when the wafer W is released from the top ring 24A, the cleaning mechanism 60 retreats initially to the retreat position. Further, the retainer ring 32 is pushed up by a push-up mechanism (not shown) for pushing up the retainer ring 32. The wafer W which has been released is received by the pusher 59, and then the pusher 59 is lowered to transfer the wafer W to the transfer stage 49 of the first linear transporter 40.

The cleaning mechanism 60 may have a function for pushing up the retainer ring 32. As will be described later, after the cleaning, the cleaning mechanism 60 moves upward to push up the retainer ring 32 of the top ring 24A and the release nozzle (described later) assists the releasing of the wafer W. The wafer W which has been released is received by the cleaning mechanism 60. Specifically, the cleaning mechanism 60 doubles as a support member for receiving the wafer W from the top ring 24A. Thereafter, the pusher 59 moves upward to pick up the wafer W from below. Then, the cleaning mechanism 60 retreats, and the pusher 59 is lowered to transfer the wafer W to the transfer stage 49 of the first linear transporter 40.

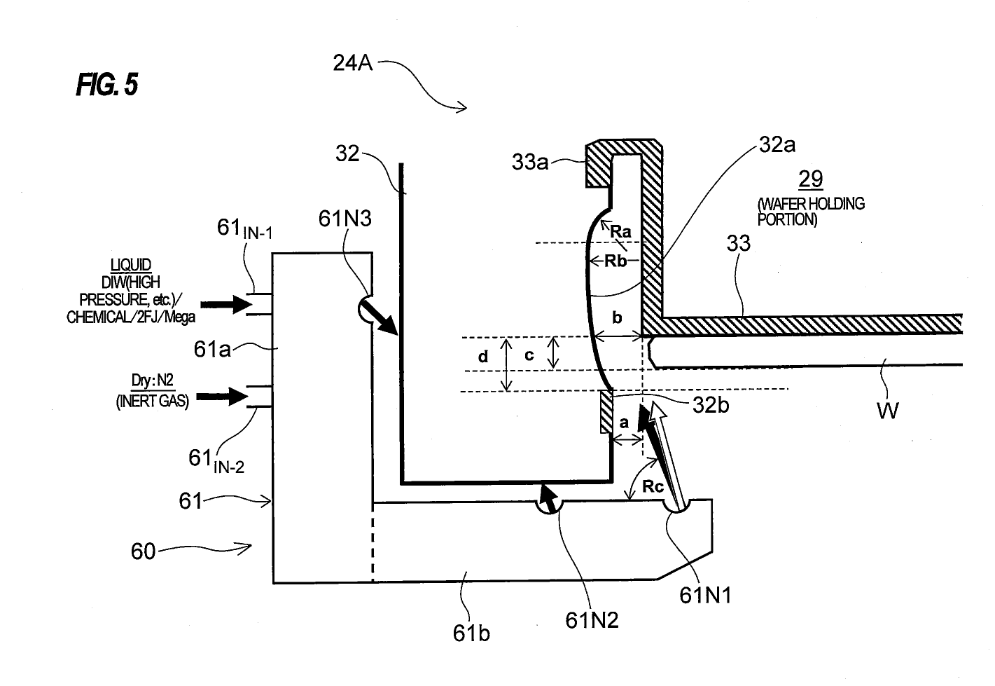

FIG. 5 is a schematic cross-sectional view showing the relationship between the top ring 24A and each cleaning unit 61 of the cleaning mechanism 60. As shown in FIG. 5, the top ring 24A comprises the top ring body 29 and the retainer ring 32 provided at the outer circumferential portion of the top ring body 29. The top ring body 29 has the membrane 33 configured to hold the wafer W and to form a pressure chamber. In FIG. 5, the state in which the retainer ring 32 is lowered downwardly with respect to the membrane 33. The cleaning unit 61 is disposed so as to face the outer circumferential surface and the bottom surface of the retainer ring 32. The retainer ring 32 has a recess 32a having an arched and curved cross-sectional shape in the inner circumferential surface of the retainer ring 32. The recess 32a is formed over an entire circumference of the inner circumferential surface of the retainer ring 32. A hydrophobic surface treatment is applied to or a hydrophobic member 32b is provided on the surface below the lower end of the recess 32a of the retainer ring 32. The membrane 33 has an inverted U-shaped folded-back portion 33a at an upper end thereof, and the folded-back portion 33a is coupled to the retainer ring 32.

As shown in FIG. 5, when the distance between the inner circumferential surface of the retainer ring 32 and the outer circumferential surface of the membrane 33 is a, the distance between the inner surface of the recess 32a of the retainer ring 32 and the outer circumferential surface of the membrane 33 is b, the thickness of the wafer W is c, and the distance between the lower surface of the membrane 33 and the lower end of the recess 32a of the retainer ring 32 is d, the relationship is set to be a<b and c<d. Because the retainer ring 32 has a functional roll for holding (blocking) the outer circumference of the wafer W so that the wafer W is not deviated in an outward direction of the top ring 24A, the distance a between the inner circumferential surface of the retainer ring 32 and the outer circumferential surface of the membrane 33 is normally approximately 0.5 mm. Further, when a curvature of the upper part of the retainer ring recess 32a is Ra, and a curvature of a lower part or a central part of the retainer ring recess 32a is Rb, the relationship is set to be Ra<Rb. The upper end of the retainer ring recess 32a is positioned in the vicinity of the lower end of the folded-back portion 33a of the membrane 33.

As shown in FIG. 5, a first cleaning nozzle 61N1 for cleaning the gap between the retainer ring 32 and the membrane 33 by ejecting a cleaning liquid toward the retainer ring recess 32a is provided in the cleaning unit 61. An inclined angle Re of the first cleaning nozzle 61N1 with respect to the horizontal plane is set to be 0<Rc<90°, preferably 20°≦Rc≦80°. Because the relationship is set to be d>c as illustrated, the lower end of the retainer ring recess 32a is positioned below the wafer W. Therefore, an entrance of the retainer ring recess 32a formed between the lower end of the retainer ring recess 32a and the outer circumferential edge of wafer is widened. Thus, the cleaning liquid ejected from the first cleaning nozzle 61N1 enters from the wide entrance located at the lower end part of the retainer ring recess 32a and passes through the gap between the inner surface of the retainer ring recess 32a and the membrane 33, and is then ejected toward the inner wall of the retainer ring recess 32a from obliquely below. At this time, the retainer ring 32 is rotated together with the top ring body 29. The retainer ring recess 32a has a characteristic recess structure which is curved in a substantially arcuate shape whose curvature Rb in the lower part or central part is larger than the curvature Ra in the upper part. Therefore, the cleaning liquid ejected from the first cleaning nozzle 61N1 hits the lower part or central part of the curvature Rb in the retainer ring recess 32a and moves upward along the upper curved portion of the curvature Ra, and is then scattered from the upper end of the retainer ring recess 32a to the radially inner side and hits the upper part of the outer circumferential surface of the membrane 33. Thereafter, the cleaning liquid flows down along the outer circumferential surface of the membrane 33. Specifically, the cleaning liquid circulates from bottom to top of the retainer ring recess 32a, and then from top to bottom of the membrane 33. Thus, the circulation supply of the cleaning liquid in the gap and the discharge efficiency of the cleaning liquid from the gap are improved remarkably to clean and remove the slurry in the gap efficiently.

Further, a second cleaning nozzle 61N2 for ejecting a cleaning liquid toward a lower surface of the retainer ring 32 is provided at a position facing the lower surface of the retainer ring 32 in the cleaning unit 61. Further, a third cleaning nozzle 61N3 for ejecting a cleaning liquid toward an outer circumferential surface of the retainer ring 32 is provided at a position facing the outer circumferential surface of the retainer ring 32 in the cleaning unit 61.

As shown in FIG. 5, a supply port 61_{IN-1} for supplying the liquid into the cleaning unit 61 and a supply port 61_{IN-2} for supplying a gas into the cleaning unit 61 are provided in the outer circumferential surface of the cleaning unit 61. By supplying DIW (high pressure), a chemical, a two-fluid jet, and a liquid such as mega jet (pure water whose cleaning effect is increased by transmitting ultrasonic waves with an ultrasonic oscillator when the pure water passes through a special nozzle) from the supply port 61_{IN-1}, the liquid is ejected from the first, second and third cleaning nozzles 61N1, 61N2, 61N3 through flow passages (not shown) in the cleaning unit 61. The chemical is preferably alkali to allow zeta potentials of the slurry and the substrate surface to be homopolar. Further, by supplying an inert gas such as dry N₂ from the supply port 61_{IN-2}, the inert gas is ejected from the first, second and third cleaning nozzles 61N1, 61N2, 61N3 through flow passages in the cleaning unit 61. In FIG. 5, a black arrow extending from the first cleaning nozzle 61N1 indicates ejection of the liquid, and a white arrow extending from the first cleaning nozzle 61N1 indicates ejection of the inert gas.

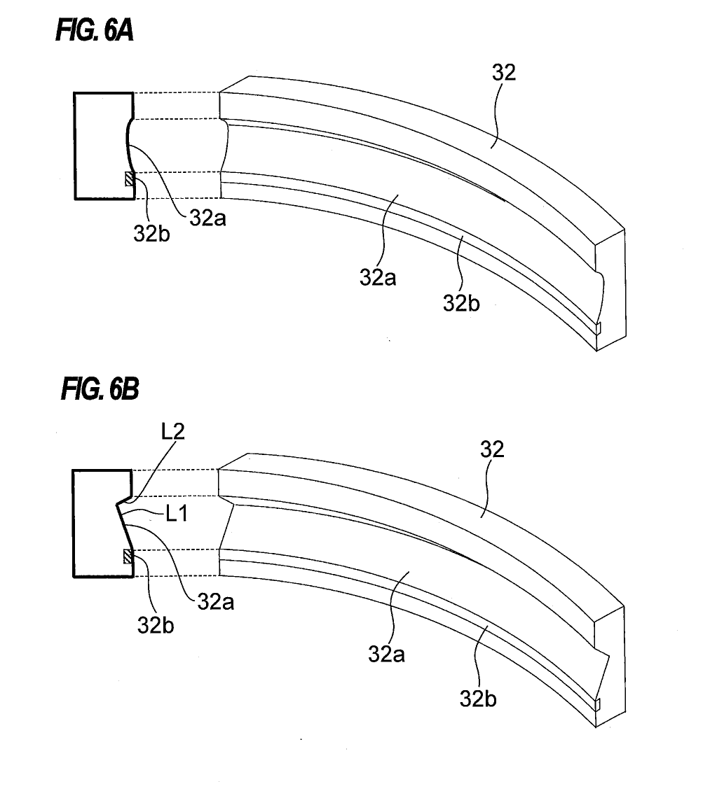

FIGS. 6A and 6B are perspective views showing the recess 32a formed in the retainer ring 32, respectively. In FIGS. 6A and 6B, end elevational views are illustrated at the left side.

In the example shown in FIG. 6A, the retainer ring recess 32a has a cross section which is arcuately curved, and is formed over the entire circumference of the inner circumferential surface of the retainer ring 32 (only a part of the retainer ring recess 32a is shown in FIG. 6A).

In the example shown in FIG. 6B, the retainer ring recess 32a has a cross section which is dented in a dogleg shape. Specifically, the retainer ring recess 32a does not have a curved cross section, but has a cross section having a dogleg shape which is formed by a straight line L1 extending obliquely upward from the lower part of the inner circumferential surface of the retainer ring 32 and a straight line L2 extending obliquely downward from the upper part of the inner circumferential surface of the retainer ring 32 which intersect with each other. The two different straight lines are set to intersect with each other at an obtuse angle.

As shown in FIGS. 6A and 6B, a hydrophobic surface treatment is applied to or a hydrophobic member 32b is provided on a surface below the retainer ring recess 32a.

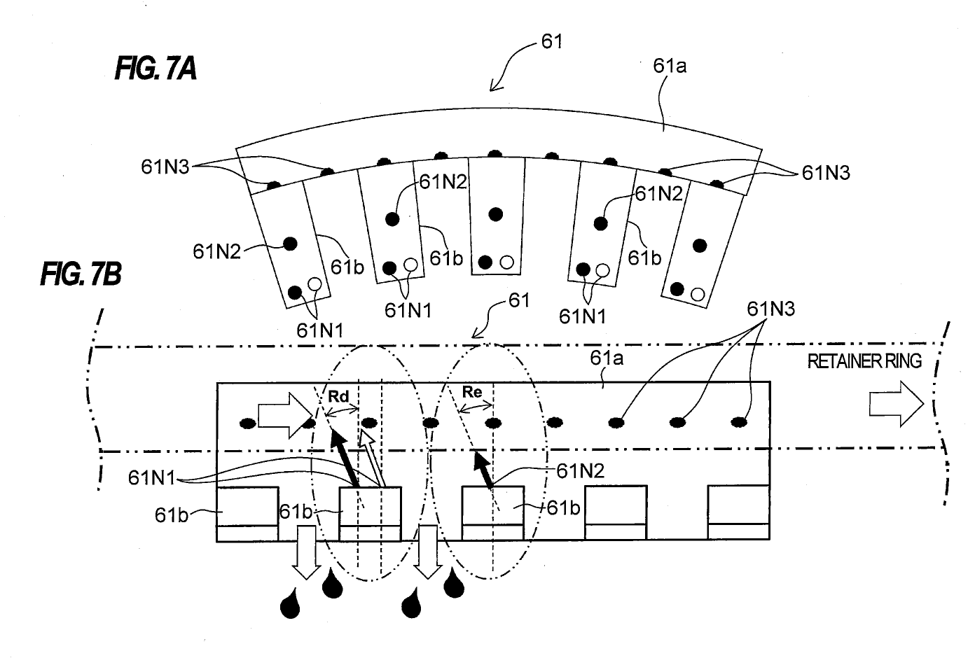

FIGS. 7A and 7B are views showing the details of the cleaning unit 61 of the cleaning mechanism 60 shown in FIG. 5. FIG. 7A is a plan view showing the cleaning unit 61, and FIG. 7B is a front view showing the cleaning unit 61. As shown in FIGS. 7A and 7B, the cleaning unit 61 comprises a curved portion 61a which is curved in a circular arc shape, and a plurality of projecting portions 61b extending from the inner circumferential surface of the curved portion 61a toward a radially inward direction of the curved portion 61a, with a gap formed between the adjacent projecting portions 61b, 61b. Therefore, the cleaning unit 61 is formed in a comb teeth shape as a whole. The two first cleaning nozzles 61N1 are provided in the tip end of each projecting portion 61b, and a single second cleaning nozzle 61N2 is provided in the central part of each projecting portion 61b. Of the two first cleaning nozzles 61N1, the black nozzle shows the nozzle for the above liquid (cleaning liquid) and the white nozzle shows the nozzle for the inert gas. Further, a plurality of third cleaning nozzles 61N3 are provided at predetermined intervals in the inner circumferential surface of the curved portion 61a. Each projecting portion 61b of the cleaning unit 61 may constitute a support member for receiving the wafer W from the top ring.

In FIG. 7B, as shown by portions (shown by alternate long and two short dashed lines) enclosed by two ellipses, the two first cleaning nozzles 61N1 are provided so as to be inclined toward the upstream side of rotation direction of the retainer ring at an inclination angle of Rd with respect to the vertical plane. The single second cleaning nozzle 62N2 is provided so as to be inclined toward the upstream side of rotation direction of the retainer ring at an inclination angle of Re with respect to the vertical plane. The inclination angles Rd and Re are set to be preferably 5°≦Rd (Re)≦60°. Therefore, the cleaning liquid ejected from the first cleaning nozzle 61N1 and the second cleaning nozzle 61N2 are set so as to hit the retainer ring wall surface in a reverse direction toward the upstream side of rotation direction of the retainer ring with respect to the moving direction of the retainer ring wall surface. Further, since the plural projecting portions 61b provided in the cleaning unit 61 have a comb teeth structure, the cleaning liquid can be efficiently discharged by gravity and supply volume (liquid and gas) without causing efficiency reduction of liquid replacement by a puddle in the lower part of the cleaning unit 61.

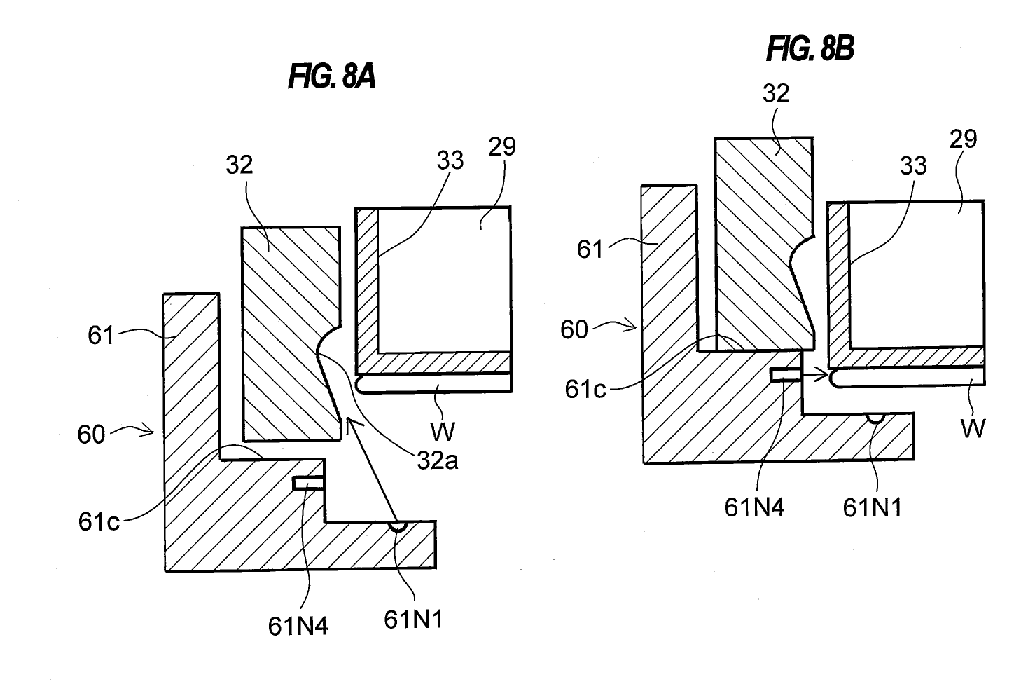

FIGS. 8A and 8B are views showing another embodiment of the cleaning mechanism 60. The cleaning mechanism 60 also has a function for removing the wafer W from the membrane 33. FIG. 8A is a schematic partial cross-sectional view showing the state in which the gap between the retainer ring 32 and the membrane 33 is cleaned. FIG. 8B is a schematic cross-sectional view showing the state in which the wafer is released. In FIGS. 8A and 8B, illustration of the second cleaning nozzle 61N2 and the third cleaning nozzle 61N3 is omitted. As shown in FIGS. 8A and 8B, each cleaning unit 61 in the cleaning mechanism 60 according to the present embodiment comprises a push-up mechanism 61c for pushing up the retainer ring 32, and a wafer release nozzle 61N4 for assisting the release of the wafer W from the membrane 33 by ejecting a fluid toward the gap between the membrane 33 and the wafer W.

As shown in FIG. 8A, when the gap is cleaned, the lower end of the retainer ring recess 32a is lowered than the lower surface of the wafer W, thus forming the state in which the cleaning liquid can be easily supplied to the retainer ring recess 32a. In this state, the cleaning liquid is ejected from the first cleaning nozzle 61N1 toward the retainer ring recess 32a to clean the gap between the membrane 33 and the retainer ring 32.

As shown in FIG. 8B, when the wafer is released, the retainer ring 32 is lifted by the push-up mechanism 61c. At this time, the lower end of the retainer ring 32 is located at a position above the lower surface of the membrane 33, and the wafer release nozzle 61N4 is located at a height of the gap between the membrane 33 and the wafer W. In this state, the fluid is ejected from the wafer release nozzle 61N4 to assist the release of the wafer W. At this time, the fluid is ejected also from the lower surface of the membrane 33 toward the wafer to remove the wafer W from the membrane 33.

The push-up mechanism 61c may project with respect to the cleaning unit 61 to lift the retainer ring 32, or the push-up mechanism 61c may comprise a contact surface which is brought into contact with the lower surface of the retainer ring 32 when the retainer ring 32 is lifted by raising the cleaning unit 61 itself.

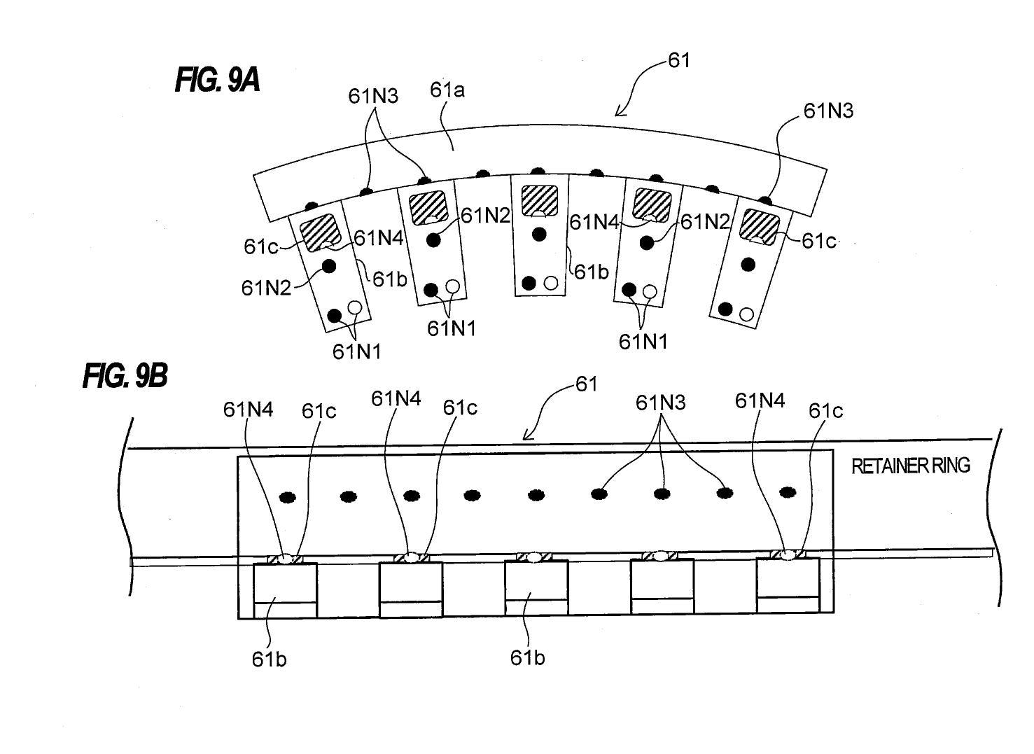

FIGS. 9A and 9B are views showing the details of the cleaning unit 61 of the cleaning mechanism 60 shown in FIG. 8. FIG. 9A is a plan view showing the cleaning mechanism 60, and FIG. 9B is a front view showing the cleaning unit 61. As shown in FIGS. 9A and 9B, a push-up mechanism 61c for pushing up the retainer ring 32 is provided on each projecting portion 61b of the cleaning unit 61. Further, a wafer release nozzle 61N4 is provided along an inner side surface of each push-up mechanism 61c. The structure of the first cleaning nozzle 61N1 to the third cleaning nozzle 61N3 is the same as that in the embodiment shown in FIGS. 7A and 7B.

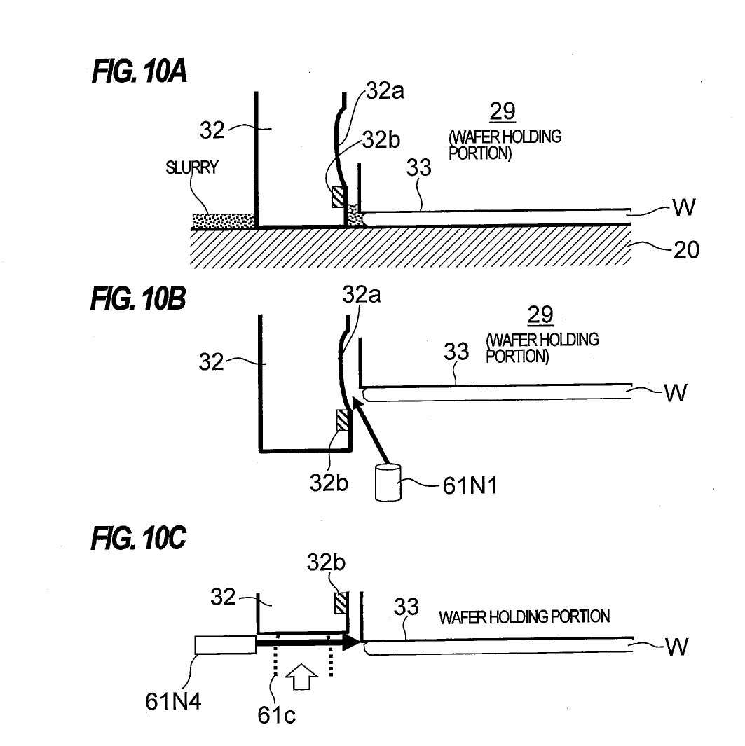

FIGS. 10A, 10B and 10C are views showing the relationship between the membrane 33 and the retainer ring 32 in the top ring 24A. FIG. 10A shows the state in which the wafer is being polished, FIG. 10B shows the state in which the wafer is transported, and FIG. 10C shows the state in which the wafer is released.

As shown in FIG. 10A, the wafer W is pressed against the polishing pad 20 by the membrane 33 provided on the top ring body (wafer holding portion) 29 and the retainer ring 32 is pressed against the polishing pad 20, thereby polishing the wafer W. At this time, the gap between the inner circumferential surface of the retainer ring 32 and the outer circumferential surface of the membrane 33 spreads inwardly by the retainer ring recess 32a, and the hydrophobic surface treatment is applied to or the hydrophobic member 32b is provided on the portion below the retainer ring recess 32a. Therefore, the liquid containing the slurry hardly enters the gap due to the capillary action. In the state in which the wafer is being polished as shown in FIG. 10A, a hydrophobic surface (not shown) is formed also on the membrane 33 at a position below the surface facing the retainer ring recess 32a to cause the liquid containing the slurry to be hardly introduced into the gap due to the capillary action.

As shown in FIG. 10B, while the wafer W is held by the membrane 33, the wafer W is transported. At this time, the retainer ring 32 is lowered downwardly, and the lower end of the retainer ring recess 32a is lowered than the lower surface of the wafer W. In this state, the cleaning liquid is ejected from the first cleaning nozzle 61N1 toward the retainer ring recess 32a. As described above, by action of the retainer ring recess 32a and action of the hydrophobic surface treatment or the hydrophobic member 32b at the portion below the retainer ring recess 32a, the slurry which enters the gap between the retainer ring 32 and the membrane 33 is small in amount. Further, because the retainer ring 32 is lowered downwardly, the slurry which has partly entered the gap is exposed outwardly, and thus can be easily cleaned. The cleaning liquid is ejected toward the inner wall of the retainer ring recess 32a from the first cleaning nozzle 61N1 to remove a small amount of slurry which has entered the gap, thus achieving a high cleaning performance. Further, according to the inner wall structure of the retainer ring recess 32a which is curved in an arcuate shape (or dogleg shape), the cleaning liquid can be circulatively supplied from bottom to top of the retainer ring recess 32a, and then from top of the retainer ring recess 32a to the membrane 33, and thus the high cleaning performance can be obtained also from this perspective.

As shown in FIG. 10C, when the wafer is released, a mixed fluid of a liquid and a gas is ejected from the wafer release nozzle 61N4 to a portion between the wafer W and the membrane 33 in a state in which the retainer ring 32 is pushed up by the push-up mechanism 61c (shown by dotted lines). As described above, the slurry which is liable to be brought into the cleaning process hardly enters the gap between the membrane 33 and the retainer ring 32, and the gap is cleaned by the first cleaning nozzle 61N1. Therefore, there is no puddle of slurry in the gap between the membrane 33 and the retainer ring 32, and thus slurry particles are prevented from being attached to the wafer surface at the time of wafer release.

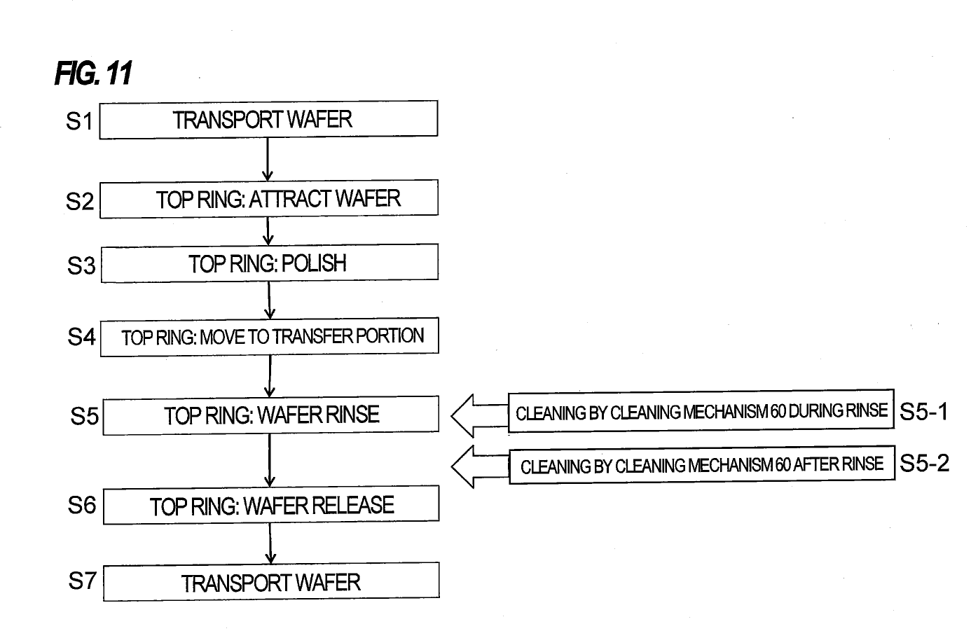

FIG. 11 is a flowchart showing an example of a wafer treatment process conducted by the polishing apparatus having the configuration shown in FIGS. 1 to 9. As shown in FIG. 11, the wafer taken out from the wafer cassette in the load ports 12 is transported to the second transfer position (wafer transfer position) TP2 of the first linear transporter 40 by the transporting mechanism (step S1). The wafer is held by the lower surface of the top ring 24A under vacuum attraction in the second transfer position (step S2). The top ring 24A which holds the wafer moves from the second transfer position TP2 to the polishing table 22A, and then the top ring 24A is lowered and the wafer is polished on the polishing table 22A (step S3). After polishing, the top ring 24A which holds the wafer moves upward and moves to the second transfer position TP2 (step S4).

In the second transfer position (wafer transfer position) TP2, the wafer is rinsed in a state in which the wafer is held by the top ring 24A. During the wafer rinse and/or after the wafer rinse, the cleaning liquid is ejected from the first cleaning nozzle 61N1, the second cleaning nozzle 61N2 and the third cleaning nozzle 61N3 in the cleaning mechanism 60, thereby cleaning the gap between the retainer ring 32 and the membrane 33 and cleaning the lower surface and the outer circumferential surface of the retainer ring 32 (steps S5-1, S5-2). In the case where the cleaning step by the cleaning mechanism 60 is conducted only when the wafer is being rinsed, the throughput (productivity) is not affected at all. In the present embodiment, the cleaning mechanism 60 has no function for the wafer release. In the present embodiment, after cleaning the gap between the retainer ring 32 and the membrane 33, the cleaning mechanism 60 retreats to the retreat position. The wafer release is performed by the action of the push-up mechanism for the retainer ring (not shown) provided separately from the cleaning mechanism 60 and the action of the wafer release nozzle (not shown) (step S6). The wafer which has been released is received by the pushed 59 (see FIGS. 4A and 4B), and then the wafer is transferred to the transfer stage 49 of the first linear transporter 40. Then, the wafer is transported to the subsequent process by the first linear transporter 40 (step S7).

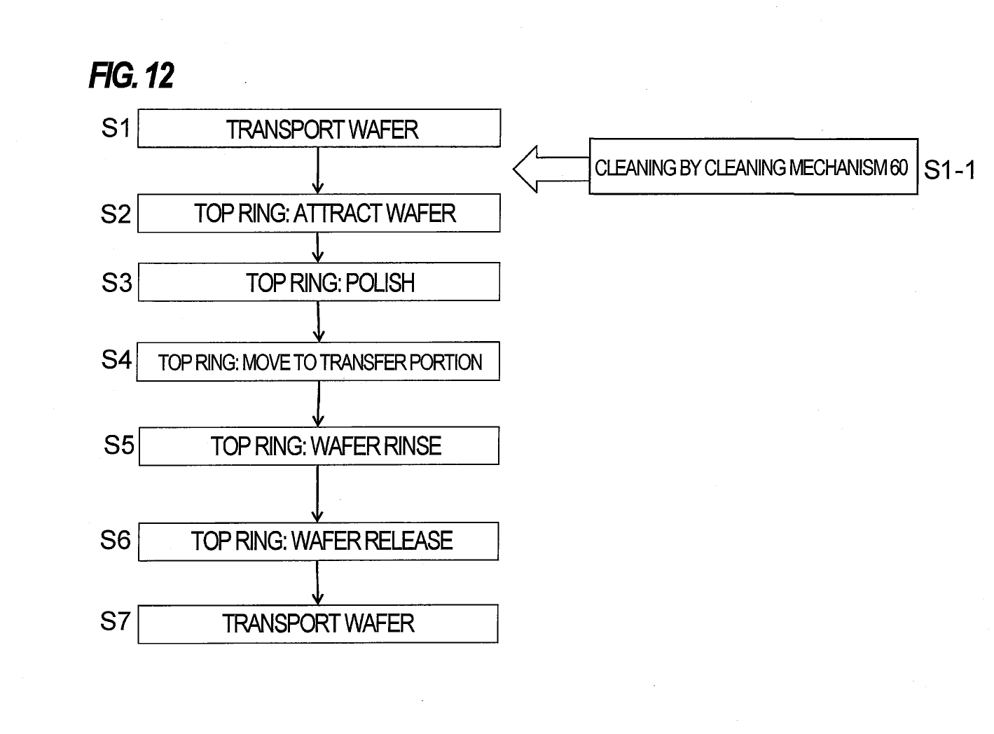

FIG. 12 is a flowchart showing another example of the wafer treatment process conducted by the polishing apparatus having the configuration shown in FIGS. 1 to 9. As shown in FIG. 12, the wafer taken out from the wafer cassette in the load ports 12 is transported to the second transfer position (wafer transfer position) TP2 of the first linear transporter 40 by the transporting mechanism (step S1). In the second transfer position (wafer transfer position) TP2, the top ring 24A is cleaned by the cleaning mechanism 60 before the top ring 24A holds the wafer. Specifically, the cleaning liquid is ejected from the first cleaning nozzle 61N1, the second cleaning nozzle 61N2 and the third cleaning nozzle 61N3 in the cleaning mechanism 60, thereby cleaning the gap between the retainer ring 32 and the membrane 33 and cleaning the lower surface and the outer circumferential surface of the retainer ring 32 (step S1-1). In this manner, by cleaning the gap between the retainer ring 32 and the membrane 33, the risk that the slurry is attached to the wafer to be subsequently held by the top ring under vacuum attraction can be reduced.

Thereafter, the wafer is held by the lower surface of the top ring 24A under vacuum attraction in the second transfer position (step S2). The top ring 24A which holds the wafer moves from the second transfer position TP2 to the polishing table 22A, and then the top ring 24A is lowered and the wafer is polished on the polishing table 22A (step S3). After polishing, the top ring 24A which holds the wafer moves upward and moves to the second transfer position TP2 (step S4). In the second transfer position (wafer transfer position) TP2, the wafer is rinsed in a state in which the wafer is held by the top ring 24A (step S5). Thereafter, the push-up mechanism 61c of the cleaning mechanism 60 moves upward to push up the retainer ring 32 and the wafer release nozzle 61N4 ejects the fluid to assist the release of the wafer W, thereby releasing the wafer from the top ring 24A (step S6). The wafer which has been released is received by the cleaning mechanism 60, and then the wafer is transferred to the transfer stage 49 of the first linear transporter 40. Then, the wafer is transported to the subsequent process by the first linear transporter 40 (step S7).

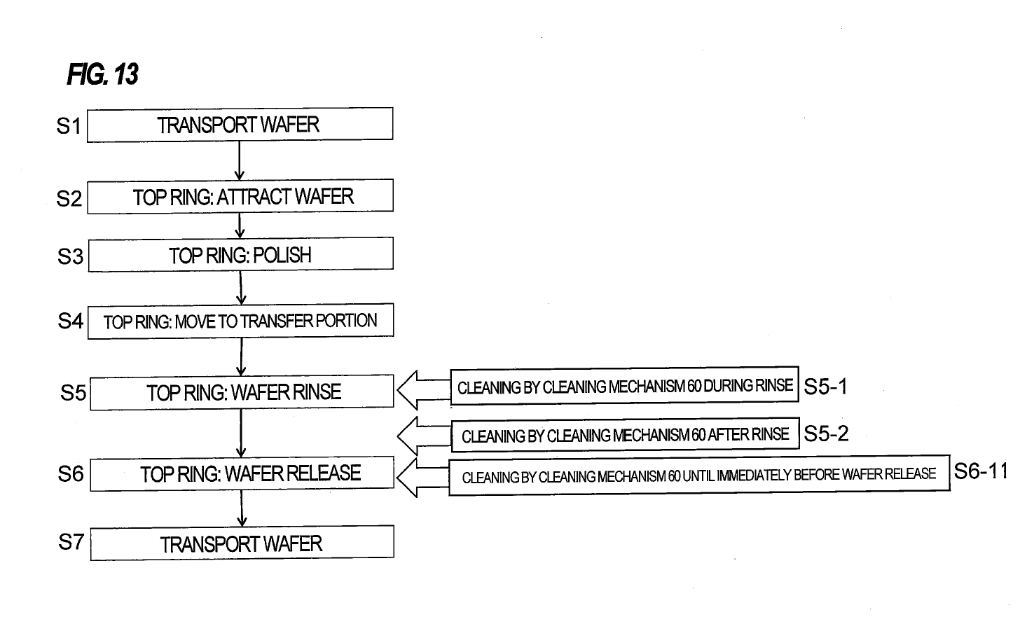

FIG. 13 is a flowchart showing still another example of the wafer treatment process conducted by the polishing apparatus having the configuration shown in FIGS. 1 to 9. As shown in FIG. 13, the wafer taken out from the wafer cassette in the load ports 12 is transported to the second transfer position (wafer transfer position) TP2 of the first linear transporter 40 by the transporting mechanism (step S1). The wafer is held by the lower surface of the top ring 24A under vacuum attraction in the second transfer position (step S2). The top ring 24A which holds the wafer moves from the second transfer position TP2 to the polishing table 22A, and then the top ring 24A is lowered and the wafer is polished on the polishing table 22A (step S3). After polishing, the top ring 24A which holds the wafer moves upward and moves to the second transfer position TP2 (step S4).

In the second transfer position (wafer transfer position) TP2, the wafer is rinsed in a state in which the wafer is held by the top ring 24A. During the wafer rinse and/or after the wafer rinse, the cleaning liquid is ejected from the first cleaning nozzle 61N1, the second cleaning nozzle 61N2 and the third cleaning nozzle 61N3 in the cleaning mechanism 60, thereby cleaning the gap between the retainer ring 32 and the membrane 33 and cleaning the lower surface and the outer circumferential surface of the retainer ring 32 (steps S5-1, S5-2). In the present embodiment, the cleaning mechanism 60 has a function for the wafer release. Specifically, the push-up mechanism 61c of the cleaning mechanism 60 moves upward to push up the retainer ring 32 and the wafer release nozzle 61N4 ejects the fluid to assist the release of the wafer W, thereby releasing the wafer from the top ring 24A (step S6). During the wafer release step also, the cleaning liquid is ejected from the second cleaning nozzle 61N2 and the third cleaning nozzle 61N3 of the cleaning mechanism 60, and thus the lower surface and the outer circumferential surface of the retainer ring 32 can be cleaned (step S6-1). The wafer which has been released is received by the cleaning mechanism 60, and is then transferred to the transfer stage 49 of the first linear transporter 40. Then, the wafer is transported to the subsequent process by the first linear transporter 40 (step S7).

Although the embodiments of the present invention have been described above, it should be noted that the present invention is not limited to the above embodiments, but may be reduced to practice in various different embodiments within the scope of the technical concept of the invention.

Although the embodiment in which the first cleaning nozzle 61N1 is provided in the cleaning mechanism 60 having a substantially L-shaped cross section has been described, the present invention is not limited to this configuration. For example, the first cleaning nozzle 61N1 may be provided around the area (particularly bottom) for transferring the substrate to the top ring or receiving the substrate from the top ring to eject the cleaning liquid toward the recess of the inner circumferential surface of the retainer ring. For example, during standby of the apparatus in which there is no substrate, the cleaning liquid is ejected toward the recess of the inner circumferential surface of the retainer ring to clean the gap between the retainer ring and the membrane.

What is claimed is:

1. A polishing apparatus comprising:
a polishing table having a polishing surface;
a top ring having a top ring body and a retainer ring provided at an outer circumferential portion of the top ring body, and configured to hold a substrate to be polished and to press the substrate against the polishing surface;
a cleaning mechanism provided at a substrate transfer position for transferring the substrate to the top ring or receiving the substrate from the top ring, and having a cleaning nozzle configured to eject a cleaning liquid toward the top ring;
wherein the retainer ring has a recess formed over an entire circumference of an inner circumferential surface of the retainer ring at a position above the lower surface of the retainer ring; and
wherein the cleaning nozzle is configured to eject the cleaning liquid toward the recess of the retainer ring.

2. The polishing apparatus according to claim 1, wherein the cleaning mechanism further comprises a substrate release nozzle configured to eject a fluid when the substrate is released from the top ring body.

3. The polishing apparatus according to claim 1 or 2, wherein the cleaning mechanism comprises a plurality of cleaning units provided at intervals in a circumferential direction so as to surround the top ring, and each cleaning unit has the cleaning nozzle; and
wherein the cleaning nozzle is configured to eject the cleaning liquid toward the recess of the retainer ring to clean the recess of the retainer ring while the top ring is rotated.

4. The polishing apparatus according to any one of claims 1 to 3, wherein the cleaning mechanism doubles as a support member configured to receive the substrate from the top ring.

5. The polishing apparatus according to any one of claims 1 to 4, wherein the retainer ring has a hydrophobic surface on an inner circumferential surface below the recess.

6. The polishing apparatus according to any one of claims 1 to 5, wherein the top ring body has a hydrophobic surface at least below the surface facing the recess.

7. The polishing apparatus according to any one of claims 1 to 6, wherein when the top ring is located at the substrate transfer position, the lower end of the recess of the retainer ring is located at a position below the lower surface of the substrate held by the top ring.

8. The polishing apparatus according to any one of claims 1 to 7, wherein the recess of the retainer ring has a cross-sectional shape which is curved in a substantially arcuate shape whose curvature in a lower part or a central part is larger than that in an upper part.

9. The polishing apparatus according to any one of claims 1 to 7, wherein the recess of the retainer ring has a cross-sectional shape formed by a straight line extending obliquely upward from a lower part of the inner circumferential surface of the retainer ring and a straight line extending obliquely downward from an upper part of the inner circumferential surface of the retainer ring, the two straight lines intersecting at an obtuse angle.

10. The polishing apparatus according to any one of claims 1 to 9, wherein the cleaning nozzle is set such that an inclined angle with respect to a horizontal plane is in the range of 20° to 80°.

11. The polishing apparatus according to any one of claims 1 to 10, wherein the cleaning nozzle is provided to be inclined at a predetermined angle toward an upstream side of rotation direction of the retainer ring with respect to a vertical plane.

12. The polishing apparatus according to any one of claims 2 to 11, wherein the cleaning mechanism has a push-up mechanism configured to push up the retainer ring when the substrate is released from the top ring body.

13. The polishing apparatus according to any one of claims 1 to 12, wherein the cleaning nozzle is capable of ejecting a gas.

14. The polishing apparatus according to any one of claims 1 to 13, wherein the cleaning mechanism has another cleaning nozzle configured to clean a lower surface and/or an outer circumferential surface of the retainer ring.
